(19) United States
(12) Patent Application Publication
(10) Pub. No.: US 2025/0173837 A1
(43) Pub. Date: May 29, 2025

(54) METHOD AND APPARATUS FOR PANORAMIC IMAGE BLENDING

(71) Applicant: VISIT INC., Wonju-si Gangwon-do (KR)

(72) Inventors: Geun Woong RYU, Seoul (KR); Si Yeop YOON, Seoul (KR); Yong Won CHO, Seoul (KR)

(73) Assignee: VISIT INC., Wonju-si Gangwon-do (KR)

(21) Appl. No.: 18/838,687

(22) PCT Filed: Feb. 3, 2023
(86) PCT No.: PCT/KR2023/001550

§ 371 Date: Oct. 17, 2024

(30) Foreign Application Priority Data
Feb. 16, 2022 (KR) 10-2022-0020211

(51) Int. Cl. G06T 5/70; G06T 5/50; G06T 15/06

(52) U.S. Cl. CPC G06T 5/70; G06T 5/50; G06T 15/06; G06T 2207/20221; G06T 2210/21

(57) ABSTRACT

A panoramic image blending method: includes performing, with reference to the origin, a Raycast on a three-dimensional spatial region including the plurality of captured images; determining whether at least two points of intersection are generated when any one virtual line generated by performing Raycast intersects with planes of the captured images, thereby determining whether there is an overlapping region in which the captured images overlap; generating, on the basis of the overlapping region, a blending region to be synthesized between the captured images; correcting the slopes of a first image plane and a second image plane corresponding to the blending region, with reference to at least one planar point of intersection formed when the first image plane and the second image plane, which are the planes of the captured images, intersect; and generating a panoramic image by matching at least one of the captured images.

### TECHNICAL FIELD

The present disclosure relates to a panoramic image blending method and apparatus, and to a panoramic image blending method and apparatus which perform the blending and matching of a plurality of images that share an overlap region.

### BACKGROUND ART

In order to generate an image of a three-dimensional space, a panoramic image, that is, an omnidirectional image, may be generated by photographing images having various angles at a photographing location by using 360-degree camera equipment or a smart device on which a photographing module is mounted and stitching the plurality of photographing images.

As the demand for the production of virtual content is recently increased, various methods for preventing distortion that occurs during a process of stitching virtual content are sought.

### DISCLOSURE

### Technical Problem

Embodiments of the present disclosure are intended to provide a panoramic image blending method and apparatus, which check an overlap region between photographing images by performing raycasting on the basis of an origin point in a three-dimensional space and adjust the gradient of the overlap region between the photographing images.

### Technical Solution

A panoramic image blending method according to an aspect of an embodiment of the present disclosure is a panoramic image blending method using a panoramic image blending apparatus that performs image matching based on a plurality of photographing images, and includes a raycasting execution step of performing raycasting on a three-dimensional space region including a plurality of photographing images on the basis of an origin point, an overlap region determination step of determining whether an overlap region that is a region that overlaps between the photographing images is present, by determining whether intersection points that are generated as any one virtual line that is generated by performing the raycasting and planes of the photographing images are intersected are at least two, a blending region generation step of generating a blending region that is a blending target region between the photographing images, based on the overlap region, a gradient correction step of correcting gradients of a first image plane and a second image plane corresponding to the blending region, on the basis of at least one plane intersection point that is formed as the first image plane and the second image plane that are the planes of the photographing images are intersected, and an image matching step of generating a panoramic image by matching the at least one photographing image.

Furthermore, the blending region may include a first blending region that is a region of the blending region in which the at least one virtual line and the first image plane are first intersected and a second blending region that is a region of the blending region in which the at least one virtual line and the second image plane are first intersected. In the gradient correction step, the gradient of the first image plane corresponding to the first blending region may be corrected to be greater than the gradient of the second image plane corresponding to the first blending region, gradient of the first image plane corresponding to the second blending region may be corrected to be greater than the gradient of the second image plane corresponding to the second blending region.

Furthermore, in the gradient correction step, the gradient of the first image plane corresponding to the first blending region may be corrected to be increased as the gradient of the first image plane becomes distant in a first direction from the plane intersection point. The gradient of the second image plane corresponding to the second blending region may be corrected to be increased as the gradient of the second image plane becomes distant in a second direction from the plane intersection point. The first direction may be a direction from a central point of the second image plane to a central point of the first image plane, and the second direction may be a direction from the central point of the first image plane to the central point of the second image plane.

Furthermore, in the gradient correction step, the gradient of the intersection point of the second image plane corresponding to the first blending region, which intersects the same virtual line as the intersection point of the first image plane corresponding to the first blending region, may be corrected to be inversely proportional to the gradient of the intersection point of the first image plane corresponding to the first blending region. The gradient of the intersection point of the second image plane corresponding to the second blending region, which intersects the same virtual line as the intersection point of the first image plane corresponding to the second blending region, may be corrected to be inversely proportional to the gradient of the intersection point of the first image plane corresponding to the second blending region.

Furthermore, the panoramic image blending method may further include a plane distance measuring step of measuring a plane distance that is a distance between a first intersection point of the first image plane and a second intersection point of the second image plane, which intersect the same virtual line that extends from the origin point. The gradient correction step may include correcting gradients of the first intersection point of the first image plane and the second intersection point of the second image plane corresponding to the blending region, based on the plane distance.

Furthermore, the plane distance measuring step may include determining a maximum plane distance between the intersection points of the first image plane and the second image plane that intersect the same virtual line in the blending region. The gradient correction step may include calculating a distance ratio that is a ratio of the maximum plane distance and the plane distance and correcting the gradients of the first intersection point of the first image plane and the second intersection point of the second image plane corresponding to the blending region, based on the distance ratio.

Furthermore, the blending region generation step may include comparing preset distance information that is condition information on which the blending region is formed and the plane distance, and generating the blending region based on the overlap region in which the plane distance is equal to or smaller than preset distance information. The gradient correction step may include calculating a distance ratio that is a ratio of the preset distance information and the plane distance, and correcting the gradients of the first intersection point of the first image plane and the second intersection point of the second image plane corresponding to the blending region, based on the distance ratio.

Furthermore, in the gradient correction step, the gradient of the first image plane corresponding to the first blending region may be corrected to be increased as the gradient of the first image plane becomes close to the central point of the first image plane from the plane intersection point. The gradient of the second image plane corresponding to the second blending region may be corrected to be increased as the gradient of the second image plane becomes close to the central point of the second image plane from the plane intersection point.

A panoramic image blending apparatus according to another aspect of an embodiment of the present disclosure is a panoramic image blending apparatus that performs image matching based on a plurality of photographing images, and includes a raycasting execution unit configured to perform raycasting on a three-dimensional space region including a plurality of photographing images on the basis of an origin point, an overlap region determination unit configured to determine whether an overlap region that is a region that overlaps between the photographing images is present, by determining whether intersection points that are generated as any one virtual line that is generated by performing the raycasting and planes of the photographing images are intersected are at least two, a blending region generation unit configured to generate a blending region that is a blending target region between the photographing images, based on the overlap region, a gradient correction unit configured to correct gradients of a first image plane and a second image plane corresponding to the blending region, on the basis of at least one plane intersection point that is formed as the first image plane and the second image plane that are the planes of the photographing images are intersected, and an image matching unit configured to generate a panoramic image by matching the at least one photographing image.

Furthermore, the blending region may include a first blending region that is a region of the blending region in which the at least one virtual line and the first image plane are first intersected and a second blending region that is a region of the blending region in which the at least one virtual line and the second image plane are first intersected. The gradient correction unit may correct the gradient of the first image plane corresponding to the first blending region so that the gradient of the first image plane is greater than the gradient of the second image plane corresponding to the first blending region, and may correct the gradient of the first image plane corresponding to the second blending region so that the gradient of the first image plane is greater than the gradient of the second image plane corresponding to the second blending region.

Furthermore, the gradient correction unit may correct the gradient of the first image plane corresponding to the first blending region so that the gradient of the first image plane is increased as the gradient of the first image plane becomes distant in a first direction from the plane intersection point, and may correct the gradient of the second image plane corresponding to the second blending region so that the gradient of the second image plane is increased as the gradient of the second image plane becomes distant in a second direction from the plane intersection point. The first direction may be a direction from a central point of the second image plane to a central point of the first image plane, and the second direction may be a direction from the central point of the first image plane to the central point of the second image plane.

Furthermore, the panoramic image blending apparatus may further include a plane distance measuring unit configured to measure a plane distance that is a distance between a first intersection point of the first image plane and a second intersection point of the second image plane, which intersect the same virtual line that extends from the origin point. The gradient correction unit may correct gradients of the first intersection point of the first image plane and the second intersection point of the second image plane corresponding to the blending region, based on the plane distance.

Furthermore, the plane distance measuring unit may determine a maximum plane distance between the intersection points of the first image plane and the second image plane that intersect the same virtual line in the blending region. The gradient correction unit may calculate a distance ratio that is a ratio of the maximum plane distance and the plane distance and correct the gradients of the first intersection point of the first image plane and the second intersection point of the second image plane corresponding to the blending region, based on the distance ratio.

Furthermore, the blending region generation unit may compare preset distance information that is condition information on which the blending region is formed and the plane distance, and may generate the blending region based on the overlap region in which the plane distance is equal to or smaller than preset distance information. The gradient correction unit may calculate a distance ratio that is a ratio of the preset distance information and the plane distance, and may correct the gradients of the first intersection point of the first image plane and the second intersection point of the second image plane corresponding to the blending region, based on the distance ratio.

Furthermore, the gradient correction unit may correct the gradient of the first image plane corresponding to the first blending region so that the gradient of the first image plane is increased as the gradient of the first image plane becomes close to the central point of the first image plane from the plane intersection point, and may correct the gradient of the second image plane corresponding to the second blending region so that the gradient of the second image plane is increased as the gradient of the second image plane becomes close to the central point of the second image plane from the plane intersection point.

### Advantageous Effects

According to the proposed embodiment, the panoramic image blending method and apparatus of the present disclosure can prevent an edge phenomemon that occurs in the existing blending process by adjusting the gradient of an overlap region between a plurality of photographing images based on raycasting and performing blending between photographing image having the gradient adjusted.

### DESCRIPTION OF DRAWINGS

FIG. 1 is an exemplary diagram illustrating an image in which a plurality of images has been matched by a conventional image blending method.

FIG. 2 is a flowchart illustrating a panoramic image blending method according to an embodiment of the present disclosure.

FIG. 3 is a diagram illustrating a three-dimensional space in which photographing images have been disposed by the panoramic image blending method of FIG. 2.

FIG. 4 is a diagram of the three-dimensional space in FIG. 3, which is viewed on the basis of a YZ plane.

FIG. 5 is a diagram of the three-dimensional space in FIG. 3, which is viewed on the basis of an XY plane.

FIG. 6 is a diagram of a three-dimensional space in which a plurality of photographing images has been disposed by a panoramic image blending method according to another embodiment of the present disclosure, which is viewed on the basis of the XY plane.

FIG. 7 is a diagram of a three-dimensional space in which a plurality of photographing images has been disposed by a panoramic image blending method according to another embodiment of the present disclosure, which is viewed on the basis of the XY plane.

FIG. 8 is a diagram schematically illustrating a construction of a panoramic image blending apparatus that operates according to the panoramic image blending method of FIG. 2.

### BEST MODE

Advantages and characteristics of the present disclosure and a method for achieving the advantages and characteristics will become apparent from embodiments described in detail later in conjunction with the accompanying drawings. However, the present disclosure is not limited to the disclosed embodiments, but may be implemented in various different forms. The embodiments are merely provided to complete the present disclosure and to fully notify a person having ordinary knowledge in the art to which the present disclosure pertains of the category of the present disclosure. The present disclosure is merely defined by the category of the claims.

A first, a second, etc. are used to describe various components, but the components are not restricted by the terms. The terms are used to only distinguish one component from the other components. Accordingly, a first component that is described hereinafter may be a second component within the technical spirit of the present disclosure.

Throughout the specification, the same reference numeral denotes the same component.

Characteristics of several embodiments of the present disclosure may be partially or entirely coupled or combined and may be technically variously associated and driven as may be sufficiently understood by those skilled in the art. The embodiments may be independently implemented and may be implemented in an associative relation.

Meanwhile, a potential effect that has not been specifically mentioned in the specification of the present disclosure and that may be expected by technical characteristics of the present disclosure is treated as if it has been described in this specification. The present embodiment has been provided to a person having ordinary knowledge in the art to more fully describe the present disclosure. Contents illustrated in the drawings may be exaggerated and represented compared to an implementation form of an actual invention. A detailed description of a component will be omitted or described in brief if it is deemed to make the subject matter of the present disclosure unnecessarily vague.

Hereinafter, embodiments of the present disclosure are described in detail with reference to the accompanying drawings.

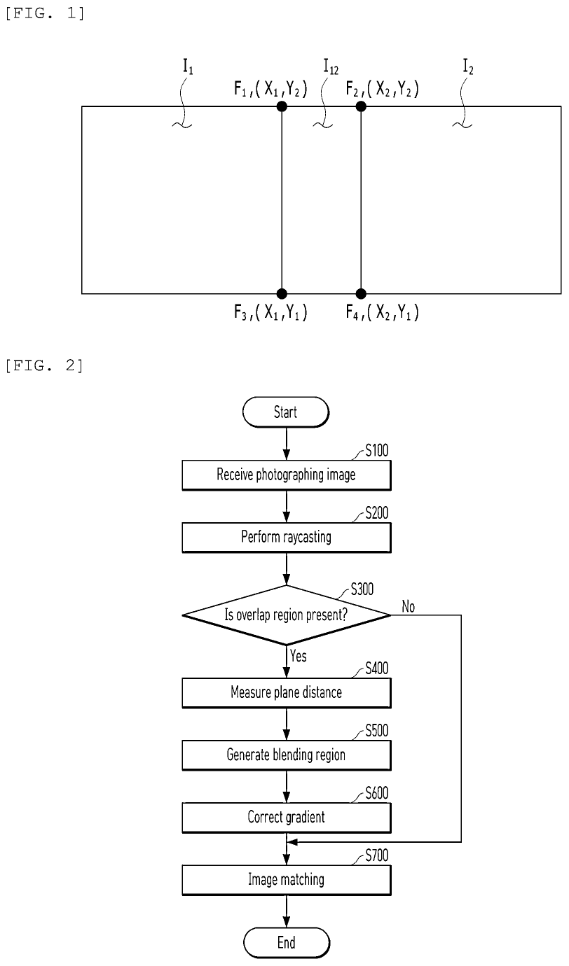

FIG. 1 is an exemplary diagram illustrating an image in which a plurality of images has been matched by a conventional image blending method.

Referring to FIG. 1, in the case of the conventional image blending method, an image matching apparatus receives a plurality of photographing images and performs stitching based on feature points that appear on the photographing images.

In this case, stitching may be performed between the photographing images by using features from accelerated segment test (FAST), scale invariant feature transform (SIFT), speeded up robust features (SURF), etc., that is, algorithms that extract the feature points s from the photographing images. An overlap region, that is, a region that is overlapped, may be formed through the results of the execution of the stitching.

In this case, the overlap region, that is, a region that has been redundantly photographed between the photographing images, is determined. After a series of corrections are performed on the overlap region, image matching is performed.

In this case, in the case of the series of corrections, the coordinates of the apex of the overlap region (I₁₂) that is formed in a rectangle may be obtained. The same masking region as the overlap region (I₁₂) may be formed based on the obtained coordinates (F₁, F₂, F₃, and F₄). Linear gradient blending may be performed on each of photographing images (I₁ and I₂) corresponding to the overlap region (I₁₂).

Illustratively, a matched blending image is generated by stitching a first image plane (I₁) and a second image plane (I₂) on a plane based on feature points that appear on the first image plane (I₂) and the second image plane (I₂), measuring a mask size through computation based on the coordinates of a first apex (F₁), second apex (F₂), third apex (F₃), and fourth apex (F₄) of the overlap region (I₁₂), that is, a region in which the first image plane (I₁) and the second image plane (I₂) overlap, modifying the gradient of each of pixels of the overlap region (I₁₂) of the photographing images based on the measured mask size, and adding the values of pixels into which the modified gradient has been incorporated.

That is, the conventional method has advantages in that masking can be easily formed and a natural connection is possible in that photographing images disposed on a plane are stitched based on feature points of the photographing images and blending between the stitched photographing images is performed.

However, if photographing images are disposed on the basis of a three-dimensional region, a complicated code is necessary to set and generate a mask region because the arrangement of the photographing images is not uniform and a form of a blending region is not uniform. A blending method using a mask method has a disadvantage in that a gradient becomes incomplete because it is difficult to normalize the blending method in a three-dimensional region.

Accordingly, if photographing images are blended based on a three-dimensional region, there are limitations in applying the method because a photographing view angle of each photographing image needs to be considered.

Accordingly, embodiments of the present disclosure propose a construction capable of the blending of three-dimensional images that are obtained based on omnidirectionally photographed images in order to solve the problems of the conventional method.

FIG. 2 is a flowchart illustrating a panoramic image blending method according to an embodiment of the present disclosure.

Referring to FIG. 2, the panoramic image blending method may include a photographing image input step S100, a raycasting execution step S200, an overlap region determination step S300, a plane distance measuring step S400, a blending region generation step S500, a gradient correction step S600, and an image matching step S700.

First, the photographing image input step $100 of receiving, by a panoramic image blending apparatus, a photographing image, that is, an image photographed by a photographing module, is performed.

In this case, the panoramic image blending apparatus may be at least one of arbitrary devices capable of image processing, such as a computer, a mobile phone, a smart hub, a laptop computer, and an IoT device on each of which a processor that performs the panoramic image blending method has been mounted.

In the photographing image input step S100, the panoramic image blending apparatus may receive the photographing image photographed by the photographing module that is included inside or outside the panoramic image blending apparatus, and may perform a task for the blending and matching of a plurality of photographing images.

In this case, the photographing image may include photographing posture information CI including yaw, pitch, and roll values, that is, camera posture information of the photographing image.

In this case, the received photographing images may be disposed in a three-dimensional space based on the photographing posture information CI of the photographing image that is input in the photographing image input step S100. A pixel of each of the disposed photographing images may correspond to a coordinate value corresponding to a three-dimensional coordinate system.

Thereafter, the raycasting execution step S200 of performing raycasting on a three-dimensional space region including the plurality of photographing images on the basis of an origin point C is performed.

In this case, the origin point C is the coordinate of the origin point, that is, a reference for a camera point of view for the three-dimensional space. An image plane region of the photographing image disposed in the three-dimensional space region may be determined by performing raycasting in an all-round direction from the origin point.

Specifically, in the raycasting execution step S200, a virtual line R that extends in the all-round direction from the origin point may be formed in the three-dimensional space region by performing raycasting. The location of an image plane of at least one photographing image disposed in the three-dimensional space region, which collides against the virtual line R, or a relation between the image planes may be checked.

That is, it is possible to determine on which coordinates of the three-dimensional region the photographing image is to be disposed because it is possible to identify an intersection point at which the virtual line R generated by performing the raycasting and the image plane of the photographing image are intersected.

Thereafter, the overlap region determination step S300 of determining whether an overlap region, that is, a region that overlaps between the photographing images, is present by determining whether the intersection point that is generated as any one virtual line R generated by performing the raycasting and the plane of the photographing image are intersected is at least two is performed.

Specifically, in the overlap region determination step S300, when it is determined that the intersection points that are generated as any one virtual line generated by performing the raycasting and the plane of the photographing image are intersected is at least two, the overlap region may be generated based on the intersection points of the image planes.

In this case, the overlap region is a region that is redundantly photographed between the plurality of photographing images, and is a region in which blending or matching may be performed between the plurality of photographing images.

Thereafter, the plane distance measuring step S400 of measuring a plane distance “d”, that is, a distance between a first intersection point of a first image plane (I₁) and a second intersection point of a second image plane (I₂) that intersect the same virtual line R that extends from the origin point, may be performed.

In this case, the plane distance measuring step S400 may be selectively performed in order to measure the plane distance “d” between the image planes of the photographing images disposed in the three-dimensional space region and to perform gradient corrections on a blending region BI included in the image planes based on the distance ratio of a maximum plane distance (d_{L}) or preset plane distance (dₘₐₓ) of the overlap region according to an embodiment of the present disclosure and the measured plane distance “d” or in order to generate the blending region BI based on the preset distance information (dₘₐₓ).

That is, in the plane distance measuring step S400, the distance ratio, that is, the ratio of the maximum plane distance (d_{L}) and a plane distance (dₙ), may be calculated by determining the maximum plane distance (d_{L}) between the intersection points of the first image plane (I₁) and the second image plane (I₂) that intersect the same virtual line R in the blending region BI.

Thereafter, the blending region generation step S500 of generating the blending region, that is, a blending target region between the photographing images, based on the overlap region is performed.

In the blending region generation step S500, the blending region BI, that is, a region of the overlap region in which image corrections are performed for image matching, may be generated.

In this case, the image correction may be a task for correcting the gradient of a pixel for smooth blending between the blending regions of the photographing images, but is not limited thereto. At least one of various image correction tasks, such as noise cancellation and sharpness corrections for reducing an edge that occurs while blending regions between photographing images are composed, may be performed as the image correction.

In this case, the blending region BI may include a first blending region (BI₁), that is, a region in which at least one virtual line R and the first image plane (I₁) are first intersected, and a second blending region (BI₂), that is, a region in which the at least one virtual line R and the second image plane (I₂) are first intersected.

In the blending region generation step S500, blending between the plurality of photographing images may be performed based on the blending region BI that is generated as the same region as the overlap region. However, in another embodiment, in the blending region generation step S500, the blending region BI may be generated to be equal to or smaller than the overlap region because the blending region BI is generated based on the overlap region in which the plane distance “d” is equal to or smaller than preset distance information (dₘₐₓ) by comparing the preset distance information (dₘₐₓ), that is, condition information on which the blending region BI is formed, and the plane distance “d”.

In this case, the preset distance information (dₘₐₓ) is distance information including the plane distance “d”, which limits a distance between the image planes of the photographing images that intersect the same virtual line R generated from the origin point C by performing the raycasting, within a predetermined range, and may be distance information that has been previously input and set by a user.

Thereafter, the gradient correction step S600 of correcting the gradients of the first image plane (I₁) and the second image plane (I₂) corresponding to the blending region BI on the basis of at least one plane intersection point that is formed as the first image plane (I₁) and the second image plane (I₂), that is, the planes of the photographing images, are intersected is performed.

Specifically, in the gradient correction step S600, the gradient of the first image plane (I₁) corresponding to the first blending region (BI₁) may be corrected to be greater than the gradient of the second image plane (I₂) corresponding to the first blending region (BI₁). The gradient of the first image plane (I₁) corresponding to the second blending region (BI₂) may be corrected to be greater than the gradient of the second image plane (I₂) corresponding to the second blending region (BI₂).

In this case, suitable blending between image planes that share an overlap region can be performed by correcting the gradients of the image planes corresponding to the same blending region BI so that the gradients are inversely proportional to each other and further assigning a weight to an image that is closer to a captured origin point in an image region that is obtained by capturing the same region.

In the gradient correction step S600, the gradient of the first image plane (I₁) corresponding to the first blending region (BI₁) may be corrected to be increased as the gradient becomes distant in a first direction (V₁) from a plane intersection point (BP_{C}). The gradient of the second image plane (I₂) corresponding to the second blending region (BI₂) may be corrected to be increased as the gradient becomes distant in a second direction (V₂) from the plane intersection point (BP_{c}).

In this case, the first direction (V₁) may be a direction from a central point (IP_{C2}) of the second image plane to a central point (IP_{C1}) of the first image plane. The second direction (V₂) may be a direction from the central point (IP_{C1}) of the first image plane to the central point (IP_{C2}) of the second image plane.

Specifically, in the gradient correction step S600, the gradient of the first image plane (I₁) corresponding to the first blending region (BI₁) may be corrected to be increased as the gradient becomes closer to the central point (IP_{C1}) of the first image plane from the plane intersection point (BP_{C}). The gradient of the second image plane (I₂) corresponding to the second blending region (BI₂) may be corrected to be increased as the gradient becomes closer to the central point (IP_{C2}) of the second image plane from the plane intersection point (BP_{C}).

Furthermore, in the gradient correction step S600, the gradient of the first image plane (I₁) corresponding to the first blending region (BI₁) may be corrected to be increased from the plane intersection point (BP_{C}) to a first blending boundary point. The gradient of the second image plane (I₂) corresponding to the second blending region (BI₂) may be corrected to be increased from the plane intersection point (BP_{C}) to a second blending boundary point.

In this case, the plane intersection point (BP_{C}) has the same location between the plurality of image planes, so that the gradient of a pixel at a plane intersection point corresponding to each of the image planes (I₁ and I₂) may have the same ratio.

Illustratively, the ratio of the gradients of image planes corresponding to the plane intersection point (BP_{C}) may be 5:5.

That is, in the gradient correction step S600, a weight may be reduced from another photographing image that shares an overlap region and the weight of the blending region of a photographing image that is close to the origin point C may be gradually increased, by correcting the gradient of the blending region corresponding to each image plane that is close to the origin point C so that the gradient is increased up to a blending boundary point on the basis of at least one plane intersection point (BP_{C}) that is formed as the first image plane (I₁) and the second image plane (I₂), that is, the planes of photographing images, are intersected.

In this case, in the gradient correction step S600, the gradient of the intersection point of the second image plane (I₂) corresponding to the first blending region (BI₁), which intersects the same virtual line R as the gradient of the intersection point of the first image plane (I₁) corresponding to the first blending region (BI₁), may be corrected to be inversely proportional to the gradient of the intersection point of the first image plane (I₁) corresponding to the first blending region (BI₁). The gradient of the intersection point of the second image plane (I₂) corresponding to the second blending region (BI₂), which intersects the same virtual line R as the gradient of the intersection point of the first image plane (I₁) corresponding to the second blending region (BI₂), may be corrected to be inversely proportional to the gradient of the intersection point of the first image plane (I₁) corresponding to the second blending region (BI₂).

Furthermore, in another embodiment, in the gradient correction step S600, the gradients of the first intersection point of the first image plane (I₁) and the second intersection point of the second image plane (I) corresponding to the blending region BI may be corrected based on the plane distance “d” calculated in the plane distance measuring step S500.

Specifically, in the gradient correction step S600, the distance ratio, that is, the ratio of the maximum plane distance (d_{L}) and the plane distance “d” calculated in the plane distance measuring step S500, may be calculated. The gradients of the first intersection point of the first image plane (I₁) and the second intersection point of the second image plane (I₂) corresponding to the blending region BI may be corrected based on the distance ratio.

Illustratively, when the maximum plane distance (d_{L}) of an intersection point between image planes that share any one same virtual line, which is calculated in the plane distance measuring step S500, is 10 and the plane distance “d” of an intersection point between image planes that share another virtual line is 8, the distance ratio, that is, the ratio of the maximum plane distance (d_{L}) and the plane distance “d”, may be calculated. The gradients of the first intersection point of the first image plane (I₁) and the second intersection point of the second image plane corresponding to the blending region BI, which first meet the another virtual line R, may be corrected in the ratio of 8:2 based on the calculated distance ratio.

That is, a gradient value may be calculated for each image plane according to each plane distance “d” on the basis of the maximum plane distance (d_{L}) between measured image planes. The weight of each of the image planes corresponding to the blending region BI may be adjusted by applying the calculated gradient to a pixel, that is, each intersection point.

In still another embodiment, in the gradient correction step S600, a distance ratio, that is, the ratio of the preset distance information (dₘₐₓ) and the plane distance “d”, may be calculated. The gradients of the first intersection point of the first image plane (I₁) and the second intersection point of the second image plane (I₂) corresponding to the blending region BI may be corrected based on the distance ratio.

In this case, the preset distance information (dₘₐₓ) is distance information between image planes, which is input or set by a user. Illustratively, when the preset distance information (dₘₐₓ) is 10 and a plane distance between the first intersection point of the first image plane and the second intersection point of the second image plane, which is measured based on the virtual line formed from the origin point by performing raycasting, is 7, the distance ratio, that is, the ratio of the preset distance information (dₘₐₓ) and the plane distance, may be calculated. The gradients of the first intersection point of the first image plane (I₁) and the second intersection point of the second image plane (I₂) corresponding to the blending region, which first meet the virtual line, may be corrected in the ratio of 7:3 based on the calculated distance ratio.

Thereafter, the image matching step S700 of generating a panoramic image by matching the at least one photographing image is performed.

In this case, in the image matching step S700, the panoramic image may be generated by matching the pixel values of the intersection points of the virtual lines of the image planes of photographing images that share the same virtual line.

In this case, the panoramic image may be an equirectangular panoramic image, but is not limited thereto and may be at least one panoramic image type that constitutes a 360-degree image, such as a cube map, a cylindrical shape, or a pyramid form.

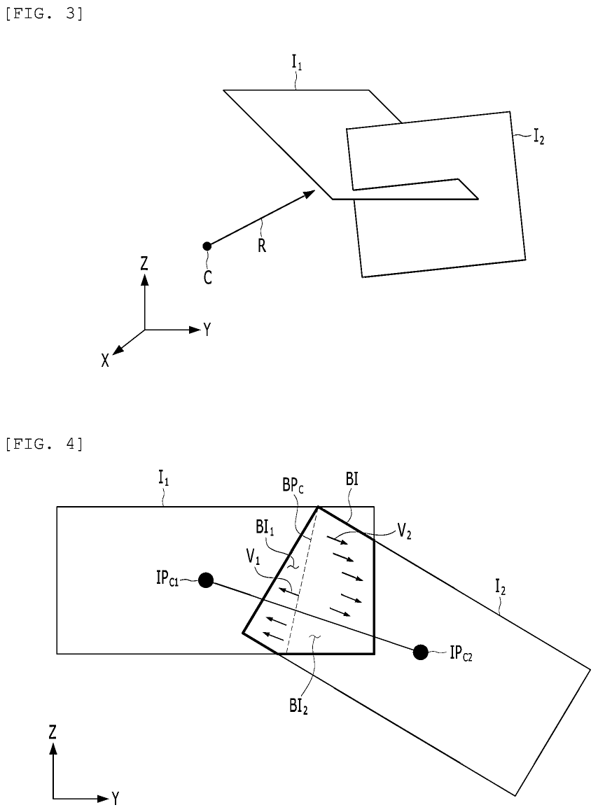

FIG. 3 is a diagram illustrating a three-dimensional space in which photographing images have been disposed by the panoramic image blending method of FIG. 2. Referring to FIG. 3, the input photographing image may be disposed in the three-dimensional space based on camera posture information of the photographing image.

In this case, the three-dimensional space may be a space having an X axis, a Y axis, and a Z axis. The virtual line R that is directed toward the image planes (I₁ and I₂) of a plurality of photographing images disposed based on the camera posture information may be formed by performing raycasting on the basis of the origin point C in the three-dimensional space.

If two or more intersection points of the same virtual line R that is formed from the origin point and the image plane of the photographing image are formed, it may be determined that the image planes (I₁ and I₂) overlap. The range of an overlap region between the image planes may be checked based on the intersection points in the same virtual line R.

In this case, the plane distance “d”, that is, distance information between the image planes (I₁ and I₂), may be measured. The blending region BI of the overlap region may be generated or the gradient of a pixel of an intersection point corresponding to two points of the measured plane distance “d” may be corrected based on the measured plane distance “d”.

FIG. 4 is a diagram of the three-dimensional space in FIG. 3, which is viewed on the basis of an YZ plane. Referring to FIG. 4, some regions of the plurality of photographing images disposed in the three-dimensional space may overlap. Blending between the photographing images may be performed based on the overlap region.

In this case, the blending region BI of an overlap region, that is, an image region that is overlappingly captured between the first image plane (I₁) of the first photographing image and the second image plane (I₂) of the second photographing image, may be generated.

The overlap region may be generated identically with the blending region BI, but some region of the overlap region may be generated as the blending region BI by user setting.

Furthermore, the at least one intersection point (BP_{C}), that is, a point at which the first image plane (I₁) of the first photographing image and the second image plane (I₂) of the second photographing image are intersected in the three-dimensional space, is generated between the first image plane (I₁) and the second image plane (I₂).

The blending region BI may include the first blending region (BI₁), that is, a region in which at least one virtual line of the blending region and the first image plane (I₁) are first intersected, and the second blending region (BI₂), that is, a region in which the at least one virtual line and the second image plane are first intersected, on the basis of the intersection point (BP_{C}).

In other words, the first blending region (BI₁) may be a blending region BI of the blending region BI in which the first image plane (I₁) is closer to the intersection point than the second image plane (I₂). The second blending region (BI₂) may be a blending region of the blending region BI in which the second image plane (I₂) is closer to the intersection point than the first image plane (I₁). The at least one intersection point (BP_{C}) may be one line segment that segments the first blending region (BI₁) and the second blending region (BI₂).

The blending region BI is a region of the overlap region of the image planes of a plurality of photographing images in which matching is performed by performing blending. A series of corrections may be performed on each of the first blending region (BI₁) and the second blending region (BI₂).

In this case, the blending region BI may be corrected so that the gradient of the image plane is increased in a direction that is formed based on the central point (IP_{C1} and IP_{C2}) of the plurality of photographing images.

Specifically, the gradient of the first image plane (I₁) corresponding to the first blending region (BI₁) may be corrected to be increased from the plane intersection point (BP_{C}) to the first blending boundary point in the first direction (V₁), that is, a direction from the central point (IP_{C2}) of the second image plane to the central point (IP_{C1}) of the first image plane. The gradient of the second image plane (I₂) corresponding to the second blending region (BI₂) may be corrected to be increased from the plane intersection point (BP_{C}) to the second blending boundary point in the second direction (V₂) from the plane intersection point (BP_{C}), that is, a direction from the central point (IP_{C1}) of the first image plane to the central point (IP_{C2}) of the second image plane.

A substantial proportion of each matched photographing image according to the distance of the photographing image may be incorporated into a blending region, by correcting the gradients of the second image plane (I₂) corresponding to the first blending region (BI₁) and the first image plane (I₁) corresponding to the first blending region (BI₁) so that the gradients of the second image plane and the first image plane are inversely proportional to each other and correcting the gradients of the first image plane (I₁) corresponding to the second blending region (BI₂) and the first image plane (I₂) corresponding to the second blending region (BI₂) so that the gradients of the first image plane and the second image plane are inversely proportional to each other.

FIG. 5 is a diagram of the three-dimensional space in FIG. 3, which is viewed on the basis of an XY plane.

Referring to FIG. 5, an overlap image plane (A₁) in which the first image plane (I₁) of the first photographing image and the second image plane (I₂) of the second photographing image overlap may be disposed in a three-dimensional space region based on the photographing posture information CI including yaw, pitch, and roll values of a photographing image.

In this case, the panoramic image blending apparatus may check that virtual lines (R₁, R₂, R₃, R₄, and R₅) that extend from the origin point C are generated, by performing raycasting on the three-dimensional space region in the all-round direction D, and intersection points that intersect the overlap image planes (I₁ and I₂) of the photographing images based on the virtual lines (R₁, R₂, R₃, R₄, and R₅).

Illustratively, the panoramic image blending apparatus may check that one image plane is present in a three-dimensional space region through which the first virtual line (R₁) and the second virtual line (R₂) pass because intersection points (CP_{R1} and CP_{R2}) at which a first virtual line (R₁) and a second virtual line (R₂) generated from the origin point C meet the image planes, respectively, are generated in the three-dimensional space region. Furthermore, the panoramic image blending apparatus may determine that the two image planes (I₁ and I₂) overlap in a three-dimensional space region through which the third virtual line (R₃), the fourth virtual line (R₄), and the fifth virtual line (R₅) pass because a third virtual line (R₃), a fourth virtual line (R₄), and a fifth virtual line (R₅) meet the two image planes (I₁ and I₂) to generate two intersection points (BP_{C}, BP₁₁ and BP₁₂, and BP₂₂ and BP₂₁).

The present disclosure is not limited thereto. The panoramic image blending apparatus may determine the number of image planes in a three-dimensional space region through which the virtual line R passes, based on the number of intersection points that are intersected by the virtual line R that is generated by performing raycasting.

Thereafter, the panoramic image blending apparatus may determine an overlap region, that is, a region overlapped based on at least two intersection points on the virtual line R, and may generate the blending region BI of the overlap region, that is, a blending target region between the photographing images.

In this case, the blending region BI may be the entire overlap region or some region of the overlap region. The panoramic image blending apparatus may perform corrections on the gradient of an image plane corresponding to the blending region BI.

The third virtual line (R₃) may intersect the first blending point (BP₁₁) of the first image plane (I₁) and the second blending point (BP₁₂) of the second image plane (I₂), that is, boundary points of the first blending region. The fifth virtual line (R₅) may intersect the third blending point (BP₂₂) of the second image plane (I₂) and the fourth blending point (BP₂₁) of the first image plane (I₁), that is, boundary points of the second blending region.

In this case, the first blending point (BP₁₁) and the second blending point (BP₁₂) may be boundary points of the first blending region (BI₁) and the second blending region (BI₂) at which blending regions in the first image plane (I₁) and the second image plane (I₂) are ended from the plane intersection point (BP_{C}).

The gradient of the first image plane (I₁) corresponding to the first blending region (BI₁) may be increased from the plane intersection point (BP_{C}) to the first blending point (BP₁₁) at which the first blending region (BI₁) is ended. The gradient of the second image plane (I₂) corresponding to second blending region (BI₂) may be increased from the plane intersection point (BP_{C}) to the third blending point (BP₂₁) at which the second blending region (BI₂) is ended.

That is, the gradient of a blending region corresponding to a close image plane, among a plurality of image planes from the origin point C, may be corrected to the increased with respect to the pixel of a blending region close to the central point (IP_{C1}, IP_{C2}), that is, the center of mass of the close image plane.

Thereafter, the panoramic image blending apparatus may indicate a plurality of image planes (A₁) of the photographing image that is disposed in the three-dimensional space region, as one image plane (A₂), by converting the plurality of image planes based on results that are generated by performing raycasting.

In this case, the panoramic image blending apparatus may generate the blending region BI including the first blending region (BI₁), that is, a blending region in which the first image plane (I₁) and the origin point C are close, and the second blending region (BI₂), that is, a blending region in which the second image plane (I₂) and the origin point C are close, based on the overlap region in which the first image plane (I₂) and the second image plane (I₂) overlap in one plane.

The first blending region (BI₁) may be formed in a range from the plane intersection point (BP_{C}) to a point (BP₁) at which the first blending point and the second blending point are blended, that is, the boundary point of the first blending region (BI₁). The second blending region (BI₂) may be formed in a range from the plane intersection point (BP_{C}) to a point (BP₂) at which the third blending point and the fourth blending point are blended, that is, the boundary point of the second blending region.

In this case, the gradient of the first image plane (I₁) corresponding to the first blending region (BI₁) may be increased in the first direction (V₁), that is, a direction from the plane intersection point (BP_{C}) to the central point (IP_{C1}) of the first image plane. The gradient of the second image plane (I₂) corresponding to the second blending region (BI₂) may be increased in the second direction (V₂), that is, a direction from the plane intersection point (BP_{C}) to the central point (IP_{C2}) of the second image plane.

Furthermore, the gradient of the second image plane (I₂) corresponding to the first blending region (BI₁) may be inversely proportional to the gradient of the first image plane (I₁) corresponding to the first blending region (BI₁). The gradient of the first image plane (I₁) corresponding to the second blending region (BI₂) may be inversely proportional to the gradient of the second image plane (I₂) corresponding to the second blending region (BI₂).

That is, the gradient of pixels of the image planes (I₁ and I₂) with which the same virtual line intersects in the blending region BI may be inversely proportional to each other.

The panoramic image blending apparatus may generate the panoramic image (A₂), that is, one image plane in which the first image plane (I₁) and the second image plane (I₂) have been blended, by correcting the gradients of the first image plane (I₁) and the second image plane (I₂) corresponding to the first blending region (BI₁) and the second blending region (BI₂), respectively, and computing pixels between the first image plane and the second image plane corresponding to the same virtual line that is generated by performing raycasting based on the corrected results.

Thereafter, a 360-degree omnidirectional image (A₃) in which an image plane of the panoramic image (A₂) that is generated based on the plurality of image planes including the blending region is converted (P) into a spherical coordinate system and projected onto a surface of the sphere may be provided to a user.

Specifically, a user can be provided with the 360-degree omnidirectional image on the basis of the origin point C, that is, capturing timing, because the panoramic image, that is, the blended image plane, is projected (P) onto the surface (L) of the sphere.

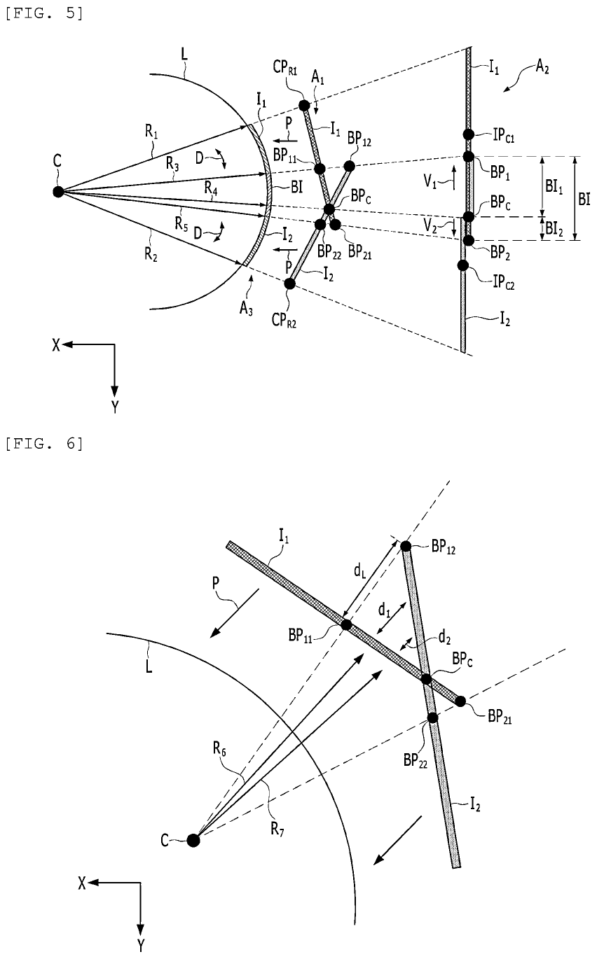

FIG. 6 is a diagram of a three-dimensional space in which a plurality of photographing images has been disposed by a panoramic image blending method according to another embodiment of the present disclosure, which is viewed on the basis of the XY plane.

Referring to FIG. 6, in another embodiment of the present disclosure, plane distances (d₁ and d₂) between a first image plane (I₁) and a second image plane (I₂) may be measured based on virtual lines (R₆ and R₇) that are generated by performing raycasting on a three-dimensional space region based on an origin point C.

Specifically, the plane distances (d₁ and d₂), that is, distances between an intersection point (BP₁₁ and BP₂₁) of the first image plane (I₁) and an intersection point (BP₁₂ and BP₂₂) of the second image plane (I₁), which intersect the same virtual lines (R₆ and R₇) that extend from the origin point C, may be measured.

In this case, a maximum plane distance (d_{L}) between the intersection points of the first image plane (I₁) and the second image plane (I₂), which intersect the same virtual line in the blending region BI of the first image plane (I₁) and the second image plane (I₂), among the measured plane distances, is determined.

Thereafter, a distance ratio, that is, the ratio of the measured plane distances (d₁ and d₂), is calculated based on the maximum plane distance (d_{L}) and each of the virtual lines. Corrections are performed on the gradient of an intersection point of the first image plane (I₁) corresponding to the blending region and the gradient of an intersection point of the second image plane (I₂), which intersects the same virtual line as the intersection point of the first image plane (I₁), based on the distance ratio.

Illustratively, when the maximum plane distance (d_{L}) between the intersection points of the first image plane (I₁) and the second image plane (I₂) is 10 and a plane distance between the intersection points of the first image plane and the second image plane that intersect the same virtual line in one blending region, among measured plane distances, is 4, the gradient of an intersection point of an image plane that belongs to the first image plane (I₁) and the second image plane (I₂) and that first intersects the virtual line, among intersection points determined as the maximum plane distance (d_{L}), and the gradient of an intersection point of an image plane that belongs to the first image plane (I₁) and the second image plane (I₂) and that first intersects the virtual line, among intersection points each having a plane distance measured as 4, may be corrected in the ratio of 10:4.

That is, among a first plane distance (d₁) and a second plane distance (d₂) measured between the first image plane (I₁) and the second image plane (I₂), the gradient of the intersection point of the first image plane (I₁) that first intersects the virtual line (R₇) on which the first plane distance (d₁) that is more distant than the second plane distance (d₂) is measured may be corrected to be greater than the gradient of the intersection point of the first image plane (I₁) that first intersects the virtual line (R₆) on which the second plane distance (d₂) is measured.

Blending regions BI corresponding to the first image plane (I₁) and the second image plane (I₂) the gradients of which have been corrected may be blended. A panoramic image may be generated by matching the first image plane (I₁) and the second image plane (I₂) that have been blended. A 360-degree omnidirectional image (A₃) may be provided to a user by converting an image plane of a panoramic image into a spherical coordinate system and projecting (P) the image plane into a surface of a sphere.

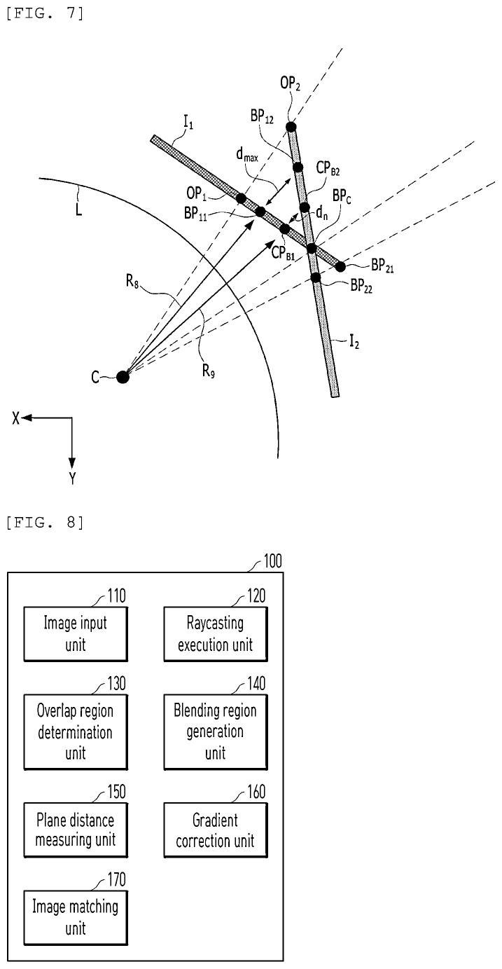

FIG. 7 is a diagram of a three-dimensional space in which a plurality of photographing images has been disposed by a panoramic image blending method according to another embodiment of the present disclosure, which is viewed on the basis of the XY plane.

Referring to FIG. 7, in another embodiment of the present disclosure, a plane distance (dₙ) between a first image plane (I₁) and a second image plane (I₂) may be measured based on a virtual line (R₉) that is generated from an origin point C by performing raycasting on a three-dimensional space region. Preset distance information (dₘₐₓ), that is, condition information on which a blending region is formed, and the plane distance (dₙ) may be compared. A blending region BI may be generated based on an overlap region in which the plane distance (dₙ) is equal to or smaller than the preset distance information (dₘₐₓ).

Illustratively, an overlap region having intersection points (OP₁, OP₂, BP₂₁, and BP₂₂), that is, end points at which a virtual line R that is generated from the origin point C in the three-dimensional space region and at least two image planes are intersected, as boundary points, may be generated. The blending region BI may be generated based on the overlap region in which the plane distance (dₙ) is equal to or smaller than the preset distance information (dₘₐₓ) by measuring the plane distance (dₙ), that is, a distance value between the image planes in the overlap region. That is, the blending region BI having an intersection point (BP₁₁ and BP₁₂) at which a plane distance is the preset distance information (dₘₐₓ) in the overlap region and an intersection point (BP₂₂ and BP₂₁), that is, a boundary point of the overlap region at which a plane distance is equal to or smaller than the preset distance information (dₘₐₓ), as boundary points may be generated.

In this case, the panoramic image blending apparatus calculates a distance ratio, that is, the ratio of the preset distance information (dₘₐₓ) and the plane distance (dₙ) that is measured based on each virtual line, and corrects the gradients of an intersection point (BP₁) of a first image plane and an intersection point (BP₂) of a second image plane corresponding to the blending region BI based on the distance ratio.

Illustratively, when the preset distance information (dₘₐₓ), that is, condition information on which a blending region is formed, is 10 and the plane distance (dₙ) between a first intersection point (CP_{B1}) and a second intersection point (CP_{B2}), that is, a point at which the image planes (I₁ and I₂) are intersected, based on any one same virtual line (R₉) is 4, the gradient of the intersection point (BP₁₁) of the first image plane (I₁) that first intersects any one virtual line (R₈) on which the plane distance (dₘₐₓ) of the preset distance information is measured and the gradient of the first intersection point (CP_{B1}), that is, a point at which any one same virtual line (R9) and the first image plane (I₁) are first intersected, may be corrected in the ratio of 10:4.

In this case, the gradient of an intersection point of an image plane that first intersects the virtual line R that is extended and formed from the origin point C may be inversely proportional to the gradient of an intersection point of another image plane that subsequently intersects the virtual line.

Furthermore, the gradient of the intersection point of the image plane that first intersects the virtual line R may be corrected to be greater than the gradient of an intersection point of another image plane that subsequently intersects the virtual line.

Thereafter, a panoramic image may be generated by blending blending regions corresponding to the first image plane (I₁) and the second image plane (I₂) having the gradients corrected and matching the first image plane (I₁) and the second image plane (I₂) that have been blended.

In the present embodiments, the blending constructions based on two image planes have been illustrated, but the present disclosure is not limited thereto. If three or more image planes intersect the same virtual line by performing raycasting, the gradient of an intersection point of each image plane may be corrected based on a plane distance between two image planes that are close to an origin point.

FIG. 8 is a diagram schematically illustrating a construction of the panoramic image blending apparatus that operates according to the panoramic image blending method of FIG. 2.

First, the panoramic image blending apparatus 100 may include an image input unit 110, a raycasting execution unit 120, an overlap region determination unit 130, a blending region generation unit 140, a plane distance measuring unit 150, a gradient correction unit 160, and an image matching unit 170.

First, the image input unit 110 may receive a plurality of photographing images by using a photographing module.

In this case, the image input unit 110 may dispose the photographing images in a three-dimensional space base on photographing posture information CI of the input photographing images.

The raycasting execution unit 120 performs raycasting on a three-dimensional space region including the plurality of photographing images on the basis of an origin point.

In this case, the origin point is a point at which coordinates in the three-dimensional region are 0. The raycasting execution unit 120 may form the virtual line R that omnidirectionally extends from the origin point in the three-dimensional space region.

The overlap region determination unit 130 determines whether an overlap region, that is, a region that overlaps between the photographing images, is present, by determining whether the number of intersection points that are generated as any one virtual line R generated by performing the raycasting and the image plane I of the photographing image are intersected is at least two.

The overlap region determination unit 130 may generate the overlap region based on the at least two intersection points that are generated as any one virtual line R generated by performing the raycasting and the image plane I of the photographing image are intersected, and may determine whether the overlap region between the photographing images is present as the overlap region is generated.

The blending region generation unit 140 generates the blending region BI, that is, a blending target region between the photographing images, based on the overlap region.

In this case, the blending region BI may include the first blending region (BI₁), that is, a region in which at least one virtual line R and the first image plane (I₁) are first intersected, and the second blending region (BI₂), that is, a region in which the at least one virtual line R and the second image plane (I₂) are first intersected.

The blending region generation unit 140 may compare the preset distance information (dₘₐₓ), that is, condition information on which the blending region BI is formed, and the plane distance (dₙ) that is measured between the image planes by performing raycasting, and may generate the blending region BI based on the overlap region in which the plane distance (dₙ) is equal to or smaller than the preset distance information (dₘₐₓ).

The plane distance measuring unit 150 measures the plane distance “d”, that is, a distance between the first intersection point of the first image plane (I₁) and the second intersection point of the second image plane (I₂) that intersect the same virtual line R that extends from the origin point C.

The plane distance measuring unit 150 may determine the maximum plane distance (d_{L}) between the intersection points of the first image plane (I₁) and the second image plane (I₂) that intersect the same virtual line in the blending region BI.

The gradient correction unit 160 corrects the gradients of the first image plane (I₁) and the second image plane (I₂) corresponding to the blending region BI, on the basis of at least one plane intersection point that is formed as the first image plane (I₁) and the second image plane (I₂), that is, the planes of the photographing images, are intersected.

The gradient correction unit 160 may correct the gradient of the first image plane (I₁) corresponding to the first blending region (BI₁) and the gradient of the second image plane (I₂) corresponding to the first blending region (BI₁) so that the gradient of the first image plane is greater than the gradient of the second image plane, and may correct the gradient of the first image plane (I₁) corresponding to the second blending region (BI₂) and the gradient of the second image plane (I₂) corresponding to the second blending region (BI₂) so that the gradient of the first image plane is greater than the gradient of the second image plane.

The gradient correction unit 160 may correct the gradient of the first image plane (I₁) corresponding to the first blending region (BI₁) so that the gradient of the first image plane is increased as the gradient becomes distant in the first direction (V₁) from the plane intersection point (BP_{C}), and may correct the gradient of the second image plane (I₂) corresponding to the first blending region (BI₁) so that the gradient of the second image plane is increased as the gradient becomes distant in the second direction (V₂) on the basis of the plane intersection point (BP_{C}).

In this case, the first direction (V₁) may be a direction from the central point (IP_{C2}) of the second image plane to the central point (IP_{C1}) of the first image plane. The second direction (V₂) may be a direction from the central point (IP_{C1}) of the first image plane to the central point (IP_{C2}) of the second image plane.

Specifically, the gradient correction unit 160 may correct the gradient of the first image plane (I₁) corresponding to the first blending region (BI₁) so that the gradient of the first image plane is increased as the gradient becomes closer to the central point (IP_{C1}) of the first image plane from the plane intersection point (BP_{C}), and may correct the gradient of the second image plane (I₂) corresponding to the second blending region (BI₂) so that the gradient of the second image plane is increased as the gradient becomes closer the central point (IP_{C2}) of the second image plane from the plane intersection point (BP_{C}).

Furthermore, the gradient correction unit 160 may correct the gradient of the first image plane (I₁) corresponding to the first blending region (BI₁) so that the gradient of the first image plane is increased from the plane intersection point (BP_{C}) to the first blending boundary point (BP₁) in the first direction (V₁), that is, a direction from the central point of the second image plane (I₂) to the central point of the first image plane (I₁), and may correct the gradient of the second image plane (I₂) corresponding to the second blending region (BI₂) so that the gradient of the second image plane is increased from the plane intersection point (BP_{C}) to the second blending boundary point (BP₂) in the second direction (V₂), that is, a direction from the central point of the first image plane (I₁) to the central point of the second image plane (I₂).

Furthermore, the gradient correction unit 160 may correct the gradients of the first intersection point of the first image plane (I₁) and the second intersection point of the second image plane (I₂) corresponding to the blending region BI, based on the plane distance “d”.

The gradient correction unit 160 may calculate a distance ratio, that is, the ratio of the maximum plane distance (d_{L}) between the intersection points of the first image plane (I₁) and the second image plane (I₂), which intersect the same virtual line in the blending region BI, and the plane distance “d”, that is, a distance between the first intersection point of the first image plane (I₁) and the second intersection point of the second image plane (I₂), which intersect the same virtual line R that extends from the origin point C, and may correct the gradients of the first intersection point of the first image plane (I₁) and the second intersection point of the second image plane (I₂) corresponding to the blending region BI, based on the distance ratio.

The gradient correction unit 160 may calculate a distance ratio, that is, the ratio of the preset distance information (dₘₐₓ) and the plane distance, and may correct the gradients of the first intersection point of the first image plane (I₁) and the second intersection point of the second image plane (I₂) corresponding to the blending region BI, based on the distance ratio.

The image matching unit 170 generates a panoramic image by matching at least one photographing image.

Specifically, the image matching unit 170 may generate a panoramic image which may be projected onto a spherical coordinate system by computing pixel values corresponding to the coordinates of image planes of photographing images that intersect the same virtual line, which are disposed in a three-dimensional space, based on a virtual line that is formed by performing raycasting.

In the aforementioned embodiments, the components and characteristics of the present disclosure have been combined in a specific form. Each of the components or characteristics may be considered to be optional unless otherwise described explicitly. Each of the components or characteristics may be implemented in a form to be not combined with other components or characteristics. Furthermore, some of the components or the characteristics may be combined to form an embodiment of the present disclosure. The sequence of the operations described in the embodiments of the present disclosure may be changed. Some of the components or characteristics of an embodiment may be included in another embodiment or may be replaced with corresponding components or characteristics of another embodiment. It is evident that an embodiment may be constructed by combining claims not having an explicit citation relation in the claims or may be included as a new claim by amendments after filing an application.

The embodiment according to the present disclosure may be implemented by various means, for example, hardware, firmware, software or a combination of them. In the case of an implementation by hardware, the embodiment of the present disclosure may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In the case of an implementation by firmware or software, the embodiment of the present disclosure may be implemented in the form of a module, procedure or function for performing the aforementioned functions or operations. Software code may be stored in the memory and driven by the processor. The memory may be located inside or outside the processor and may exchange data with the processor through a variety of known means.

It is evident to those skilled in the art that the present disclosure may be embodied in other specific forms without departing from the essential characteristics of the present disclosure. Accordingly, the detailed description should not be construed as being limitative from all aspects, but should be construed as being illustrative. The scope of the present disclosure should be determined by reasonable analysis of the attached claims, and all changes within the equivalent range of the present disclosure are included in the scope of the present disclosure.

Furthermore, although the preferred embodiments of the present disclosure have been described above, the present disclosure is not limited to the embodiments, but may be modified and embodied in various ways within the claims, the detailed description of the present disclosure, and the accompanying drawings, which may also belong to the scope of the present disclosure.

### MODE FOR DISCLOSURE

A form for implementing the disclosure has also been described in the best mode for implementing the disclosure.

### INDUSTRIAL APPLICABILITY

The present disclosure relates to the panoramic image blending method and apparatus and has repeatability and industrial applicability in a panoramic image blending method and apparatus for generating a panoramic image.

1. A panoramic image blending method using a panoramic image blending apparatus that performs image matching based on a plurality of photographing images, the panoramic image blending method comprising:
a raycasting execution step of performing raycasting on a three-dimensional space region comprising a plurality of photographing images on the basis of an origin point;
an overlap region determination step of determining whether an overlap region that is a region that overlaps between the photographing images is present, by determining whether intersection points that are generated as any one virtual line that is generated by performing the raycasting and planes of the photographing images are intersected are at least two;
a blending region generation step of generating a blending region that is a blending target region between the photographing images, based on the overlap region;
a gradient correction step of correcting gradients of a first image plane and a second image plane corresponding to the blending region, on the basis of at least one plane intersection point that is formed as the first image plane and the second image plane that are the planes of the photographing images are intersected; and
an image matching step of generating a panoramic image by matching the at least one photographing image.

2. The panoramic image blending method of claim 1, wherein:
the blending region comprises a first blending region that is a region of the blending region in which the at least one virtual line and the first image plane are first intersected and a second blending region that is a region of the blending region in which the at least one virtual line and the second image plane are first intersected, and
in the gradient correction step, the gradient of the first image plane corresponding to the first blending region is corrected to be greater than the gradient of the second image plane corresponding to the first blending region, and the gradient of the first image plane corresponding to the second blending region is corrected to be greater than the gradient of the second image plane corresponding to the second blending region.

3. The panoramic image blending method of claim 2, wherein in the gradient correction step,
the gradient of the first image plane corresponding to the first blending region is corrected to be increased as the gradient of the first image plane becomes distant in a first direction from the plane intersection point,
the gradient of the second image plane corresponding to the second blending region is corrected to be increased as the gradient of the second image plane becomes distant in a second direction from the plane intersection point, and
the first direction is a direction from a central point of the second image plane to a central point of the first image plane, and the second direction is a direction from the central point of the first image plane to the central point of the second image plane.

4. The panoramic image blending method of claim 3, wherein in the gradient correction step,
the gradient of the intersection point of the second image plane corresponding to the first blending region, which intersects the same virtual line as the intersection point of the first image plane corresponding to the first blending region, is corrected to be inversely proportional to the gradient of the intersection point of the first image plane corresponding to the first blending region, and
the gradient of the intersection point of the second image plane corresponding to the second blending region, which intersects the same virtual line as the intersection point of the first image plane corresponding to the second blending region, is corrected to be inversely proportional to the gradient of the intersection point of the first image plane corresponding to the second blending region.

5. The panoramic image blending method of claim 4, further comprising a plane distance measuring step of measuring a plane distance that is a distance between a first intersection point of the first image plane and a second intersection point of the second image plane, which intersect the same virtual line that extends from the origin point,
wherein the gradient correction step comprises correcting gradients of the first intersection point of the first image plane and the second intersection point of the second image plane corresponding to the blending region, based on the plane distance.

6. The panoramic image blending method of claim 5, wherein:
the plane distance measuring step comprises determining a maximum plane distance between the intersection points of the first image plane and the second image plane that intersect the same virtual line in the blending region, and
the gradient correction step comprises calculating a distance ratio that is a ratio of the maximum plane distance and the plane distance and correcting the gradients of the first intersection point of the first image plane and the second intersection point of the second image plane corresponding to the blending region, based on the distance ratio.

7. The panoramic image blending method of claim 5, wherein:
the blending region generation step comprises comparing preset distance information that is condition information on which the blending region is formed and the plane distance, and generating the blending region based on the overlap region in which the plane distance is equal to or smaller than preset distance information, and
the gradient correction step comprises calculating a distance ratio that is a ratio of the preset distance information and the plane distance, and correcting the gradients of the first intersection point of the first image plane and the second intersection point of the second image plane corresponding to the blending region, based on the distance ratio.

8. The panoramic image blending method of claim 3, wherein in the gradient correction step,
the gradient of the first image plane corresponding to the first blending region is corrected to be increased as the gradient of the first image plane becomes close to the central point of the first image plane from the plane intersection point, and
the gradient of the second image plane corresponding to the second blending region is corrected to be increased as the gradient of the second image plane becomes close to the central point of the second image plane from the plane intersection point.

9. A panoramic image blending apparatus that performs image matching based on a plurality of photographing images, the panoramic image blending apparatus comprising:
a raycasting execution unit configured to perform raycasting on a three-dimensional space region comprising a plurality of photographing images on the basis of an origin point;
an overlap region determination unit configured to determine whether an overlap region that is a region that overlaps between the photographing images is present, by determining whether intersection points that are generated as any one virtual line that is generated by performing the raycasting and planes of the photographing images are intersected are at least two;
a blending region generation unit configured to generate a blending region that is a blending target region between the photographing images, based on the overlap region;
a gradient correction unit configured to correct gradients of a first image plane and a second image plane corresponding to the blending region, on the basis of at least one plane intersection point that is formed as the first image plane and the second image plane that are the planes of the photographing images are intersected; and
an image matching unit configured to generate a panoramic image by matching the at least one photographing image.

10. The panoramic image blending apparatus of claim 9, wherein:
the blending region comprises a first blending region that is a region of the blending region in which the at least one virtual line and the first image plane are first intersected and a second blending region that is a region of the blending region in which the at least one virtual line and the second image plane are first intersected, and
the gradient correction unit corrects the gradient of the first image plane corresponding to the first blending region so that the gradient of t image plane is greater than the gradient of the second image plane corresponding to the first blending region, and corrects the gradient of the first image plane corresponding to the second blending region so that the gradient of the first image plane is greater than the gradient of the second image plane corresponding to the second blending region.

11. The panoramic image blending apparatus of claim 10, wherein:
the gradient correction unit corrects the gradient of the first image plane corresponding to the first blending region so that the gradient of the first image plane is increased as the gradient of the first image plane becomes distant in a first direction from the plane intersection point, and corrects the gradient of the second image plane corresponding to the second blending region so that the gradient of the second image plane is increased as the gradient of the second image plane becomes distant in a second direction from the plane intersection point, and
the first direction is a direction from a central point of the second image plane to a central point of the first image plane, and the second direction is a direction from the central point of the first image plane to the central point of the second image plane.

12. The panoramic image blending apparatus of claim 11, further comprising a plane distance measuring unit configured to measure a plane distance that is a distance between a first intersection point of the first image plane and a second intersection point of the second image plane, which intersect the same virtual line that extends from the origin point,
wherein the gradient correction unit corrects gradients of the first intersection point of the first image plane and the second intersection point of the second image plane corresponding to the blending region, based on the plane distance.

13. The panoramic image blending apparatus of claim 12, wherein:
the plane distance measuring unit determines a maximum plane distance between the intersection points of the first image plane and the second image plane that intersect the same virtual line in the blending region, and
the gradient correction unit calculates a distance ratio that is a ratio of the maximum plane distance and the plane distance and correct the gradients of the first intersection point of the first image plane and the second intersection point of the second image plane corresponding to the blending region, based on the distance ratio.

14. The panoramic image blending apparatus of claim 12, wherein
the blending region generation unit compares preset distance information that is condition information on which the blending region is formed and the plane distance and generates the blending region based on the overlap region in which the plane distance is equal to or smaller than preset distance information, and
the gradient correction unit calculates a distance ratio that is a ratio of the preset distance information and the plane distance and correct the gradients of the first intersection point of the first image plane and the second intersection point of the second image plane corresponding to the blending region, based on the distance ratio.

15. The panoramic image blending apparatus of claim 11, wherein the gradient correction unit
corrects the gradient of the first image plane corresponding to the first blending region so that the gradient of the first image plane is increased as the gradient of the first image plane becomes close to the central point of the first image plane from the plane intersection point, and
corrects the gradient of the second image plane corresponding to the second blending region so that the gradient of the second image plane is increased as the gradient of the second image plane becomes close to the central point of the second image plane from the plane intersection point.
